(19) United States
(12) Patent Application Publication
(10) Pub. No.: US 2010/0285397 A1
(43) Pub. Date: Nov. 11, 2010

(54) Hybrid catalyst, method of fabricating the same, and fuel cell comprising the same

(75) Inventors: Hong-Ming Lin, Taipei City (TW); Cheng-Han Chen, Taipei City (TW); Wei-Jen Liou, Taipei City (TW); Kuan-Nan Lin, Taipei City (TW); Wei-Syuan Lin, Taipei City (TW); She-Huang Wu, Taipei City (TW)

Correspondence Address: BACON & THOMAS, PLLC, 625 SLATERS LANE, FOURTH FLOOR, ALEXANDRIA, VA, 22314-1176, US

(73) Assignees: Tatung University, Taipei (TW); Tatung Company, Taipei (TW)

(21) Appl. No.: 12/588,126

(22) Filed: Oct. 6, 2009

(30) Foreign Application Priority Data
May 6, 2009 (TW) 098114949

(51) Int. Cl. H01M 8/10; B01J 21/18; B01J 23/42; H01M 4/88; B01J 23/06

(52) U.S. Cl. 429/528; 502/183; 502/185; 502/101; 977/742

(57) ABSTRACT

A hybrid catalyst is disclosed, which has a structure of Pt/oxygen-donor/carbon-nanotube. The hybrid catalyst has a superior electrochemical characteristic and high carbon monoxide conversion efficiency even in a low reacting temperature, and thus is useful at detoxification of carbon monoxide. Besides, the oxygen-donor utilized in the present invention is cheap and is commercially reachable, therefore the hybrid catalyst of the present invention is advantageous in commercial usage. Also, a method of fabricating the above hybrid catalyst and a fuel cell comprising the above hybrid catalyst are disclosed.

### BACKGROUND OF THE INVENTION

1. Field of the Invention

The present invention relates to a hybrid catalyst, a method of fabricating the same, and a fuel cell comprising the same. More particularly, the present invention relates to a hybrid catalyst having high efficiency of carbon monoxide conversion, which enables the problem of carbon monoxide toxicity (CO poisoning) to be solved, a method of fabricating the same, and a fuel cell comprising the same.

2. Description of Related Art

Currently, fuel cell systems are increasingly being used as a power source in a wide variety of applications. Fuel cell systems have been proposed for use in power consumers such as vehicles as a replacement for an internal combustion engines, for example. Also, fuel cell systems may be used as electric power supplies of portable electronic devices such as video cameras, computers, PDAs, cell phones, and the like.

Fuel cells are electrochemical devices which directly combine a fuel such as hydrogen and an oxidant such as oxygen to produce electricity. The oxygen is typically supplied by an air stream. The hydrogen and oxygen combine to result in the formation of water. Other fuels can be used such as natural gas, methanol, ethanol, gasoline, and coal-derived synthetic fuels. Recently, direct methanol fuel cell (DMFC) using methanol as the major fuel has drawn particular interest to researchers due to its advantages such as, for example, capability for low temperature operation, convenience for storage and transportation, charging-free, small volume, and portability.

However, during the reaction of methanol and water, an intermediate product, i.e. carbon mono-oxide, is generated and this causes toxication (poisoning) of the platinum catalyst and therefore decreases the efficiency of the platinum catalyst and causes negative influence on the performance of the direct methanol fuel cell.

Carbon mono-oxide is an intermediate product generated when a carbon atom and an oxygen atom of water react to form the carbon dioxide during the reforming of methanol. Kawabata et al. has proposed that the toxication of the platinum catalyst can be overcome by replacing the platinum catalyst with a platinum-ruthenium-alloy (Pt—Ru) as the catalyst. The added ruthenium (Ru) is helpful for the departure of the carbon mono-oxide being attached to the catalyst. However, when the amount of the carbon mono-oxide rises too fast or too high, the quantity of the Pt—Ru catalyst should be increased. With the extremely high price of the ruthenium metal, industrial application at large quantity manufacturing of the Pt—Ru catalyst is difficult since the manufacturing cost cannot be lowered. Therefore, it is a present need to provide a novel catalyst with low manufacturing cost, which enables the problem of carbon mono-oxide toxication to be solved and also maintains good electro-chemical efficiency of the battery.

### SUMMARY OF THE INVENTION

The present invention provides a hybrid catalyst comprising a carbon-nanotube; an oxygen donor formed on the surface of the carbon-nanotube, wherein the oxygen donor is a metal compound containing at least one oxygen atom, the metal of the metal compound is selected from a group consist of: cerium, titanium, tin, zinc, and the mixture thereof; and platinum formed on the surface of the oxygen donor.

The hybrid catalyst with the structure of Pt/oxygen donor/carbon-nanotube of the present invention utilizes a metal compound having oxygen, such as cerium oxide, to act as the oxygen donor for converting the carbon mono-oxide attached at the surface of the platinum into carbon dioxide, and thus enables the regeneration of the activity of the platinum and elongates the life time of the platinum. From the testing result of the cyclic voltammetry experiment, it is known that the hybrid catalyst of the present invention has a superior electrochemical characteristic either at a low temperature such as room temperature or a high temperature. Therefore, the hybrid catalyst of the present invention is effective in detoxifying the CO poisoning. Besides, the costs involved are low since the material of the oxygen donor used in the present example such as cerium oxide, titanium oxide, tin oxide, or zinc oxide is inexpensive compared with the ruthenium metal used in those prior arts. Therefore, the present invention is able to overcome the problem of CO toxicity and simultaneously is able to provide for large amount manufacturing by using the hybrid catalyst and the method of providing the same.

According to the hybrid catalyst of the present invention, the oxygen donor is preferably selected from the group consisted of: cerium oxide, titanium oxide, tin oxide, zinc oxide, and the mixture thereof, more preferably is cerium oxide or titanium oxide, most preferably is cerium oxide.

According to the hybrid catalyst of the present invention, the hybrid catalyst is preferably used in an anode of a fuel cell.

The present invention also provides a method of fabricating a hybrid catalyst, comprising adding carbon nanotubes to a first solvent (S1); adding a catalyst precursor into the first solvent with carbon nanotubes to form a first solution mixture, wherein the catalyst precursor is selected from the group consisting of: cerium compound, titanium compound, tin compound, zinc compound, and the mixture thereof (S2); drying the first solution mixture of step (S2) to form a dried residue (S3); dispersing the dried residue in a second solvent (a dispersion solvent) (S4); adding a platinum precursor to the second solvent to form a second solution mixture (S5); and drying the second solution mixture to achieve the hybrid catalyst (S6) having a structure of Pt/oxygen donor/carbon-nanotube.

The hybrid catalyst with a novel structure of Pt/oxygen donor/carbon-nanotube of the present invention is fabricated by metal oxide sol-gel method, which provides a nano-sized oxygen donor (for example, cerium oxide) to be formed on carbon-nanotubes by hydrolysis-condensation reaction, and uses a polyol method to deposit Pt nano-particles on the oxygen donor that is formed on the carbon-nanotubes. The hybrid catalyst of the present invention has an excellent electrochemical characteristic and high carbon mono-oxide transferring (i.e. CO oxidizing) efficiency even under the circumstances without heat-treatment. Besides, the cost of the material of the oxygen donor (for example, cerium oxide) in the present invention is extensively lower than the materials used for manufacturing catalysts in the prior arts. Therefore, the present invention is able to overcome the problem of CO toxicity and simultaneously is able to provide for large amount manufacturing by using the method of providing the hybrid catalyst.

According to the method of providing the hybrid catalyst of the present invention, the first solvent in the step (S1) is preferably selected from the group consisting of: alcohols, acids, ketones, and the mixture thereof; more preferably is IPA (isopropyl alcohol), ethanol, propanol, citric acid, polyethylene glycol, stearic acid, or an alcohol having eight or more carbon atoms.

According to the method of providing the hybrid catalyst of the present invention, the second solvent in the step (S4) is preferably selected from the group consisting of: an alcohol, water, and the mixture thereof.

According to the method of providing the hybrid catalyst of the present invention, a step (S31) is preferably further comprised after the step (S3), wherein the step (S31) is: performing heat-treatment to the dried residue, in which the temperature of the heat-treatment of the step (S31) is preferably 300° C. or above.

According to the method of providing the hybrid catalyst of the present invention, the catalyst precursor in the step (S2) is preferably a metal salt or a metal alkoxide.

The method of providing the hybrid catalyst of the present invention preferably further comprises a step (S41) after the step (S4), wherein the step (S41) is: heating the second solvent with the added residue, in which the heating temperature of the step (S41) is preferably 150 to 200° C. to increase the uniformity of the residue dispersed in the second solvent.

The method of providing the hybrid catalyst of the present invention preferably further comprises a step (S51) after the step (S5), wherein the step (S51) is: adjusting the pH value of the second solution mixture to 7˜9. The adjusting of the pH value can increase the uniformity of the platinum particles dispersion in the second solvent to avoid the occurrence of aggregation, and therefore enables those platinum micro-fine particles to be more uniformly formed on the oxygen donor formed on the carbon nanotubes.

The present invention still further provides a fuel cell, which comprises an anode having a hybrid catalyst; a cathode; and an electrolyte membrane disposed between the anode and the cathode; wherein the hybrid catalyst comprises a carbon-nanotube; an oxygen donor; and platinum, wherein the oxygen donor is formed on the surface of the carbon-nanotube, the oxygen donor is a metal compound containing at least one oxygen atom, the metal of the metal compound is selected from a group consisting of: cerium, titanium, tin, zinc, and the mixture thereof, and the platinum formed on the surface of the oxygen donor.

According to the fuel cell of the present invention, the oxygen donor is preferably selected from the group consisting of: cerium oxide, titanium oxide, tin oxide, zinc oxide, and the mixture thereof.

According to the fuel cell of the present invention, the oxygen donor is preferably cerium oxide or titanium oxide.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of the fuel cell of the example 6;

FIGS. 2A and 2B are the X-ray diffraction analysis results of the testing example 1;

FIG. 3 are cyclic voltammetry experiment testing results of the testing example 2; and

FIGS. 4 and 5 are the CO oxidation conversion efficiency testing results of the testing example 3.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Example 1

First, 0.05 g of carbon nanotubes is added to 50 ml of 0.02M citric acid to provide a first solution (S1). Then, 5.8 ml of 0.05M Ce(NO₃)₃.6H₂O is added to the first solution and stirred at room temperature (S2). The stirred first solution is dried, the residues (in a form of powder) are collected and are processed by heat-treatment at 700° C. for 1 hour (S3). After heat treatment, residues are dispersed in ethylene glycol (reducing agent) to provide a second solution (S4). Herein, the Ce(NO₃)₃.6H₂O used at step (S2) acts as the catalyst precursor of the present example.

Subsequently, the second solution is heated to a temperature of 170° C. and H₂PtCl₆.6H₂O (a platinum precursor) is added thereto, the pH value of the solution is then adjusted to about 8 with potassium hydroxide (S5). Finally, the solution is stirred for about 20 minutes to dry and the achieved powder is thus the hybrid catalyst with a structure of Pt/cerium oxide/carbon-nanotube of the present example.

The hybrid catalyst with a novel structure of Pt/oxygen donor/carbon-nanotube of the present invention is fabricated by metal oxide sol-gel method, which provides a nano-sized oxygen donor (for example, cerium oxide) to be formed on carbon-nanotubes by hydrolysis-condensation reaction, and uses a polyol method to deposit Pt nano-particles on the oxygen donor that is formed on the carbon-nanotubes. The hybrid catalyst of the present invention has a superior electrochemical characteristic and high carbon mono-oxide transferring (i.e. CO oxidizing) efficiency even under the circumstances without heat-treatment. Besides, the cost of the material of the oxygen donor (for example, cerium oxide) in the present invention is extensively lower than the materials used for manufacturing catalysts in the prior arts. Therefore, the present invention is able to overcome the problem of CO toxicity and simultaneously is able to provide for large amount manufacturing by using the hybrid catalyst and the method of providing the same.

### Example 2

First, 0.03 g of carbon nanotubes is added to 50 ml of isopropyl alcohol to provide a first solution (S1). Then, 50 ml of 0.007M [(CH₃)₂CHO]₄Ti (titanium (IV) isopropoxide) is added to the first solution and stirred at room temperature (S2). The stirred first solution is dried, the residues (in a form of powder) are collected and are processed by heat-treatment at 1000° C. for 1 hour (S3). After heat treatment, residues are dispersed in ethylene glycol (reducing agent) to provide a second solution (S4). Herein, the [(CH₃)₂CHO]₄Ti used at step (S2) acts as the catalyst precursor of the present example.

Subsequently, the second solution is heated to a temperature of 170° C. and H₂PtCl₆.6H₂O (a platinum precursor) is added thereto, the pH value of the solution is then adjusted to about 8 with potassium hydroxide (S5). Finally, the solution is stirred for about 20 minutes to dry and the achieved powder is thus the hybrid catalyst with a structure of Pt/titanium oxide/carbon-nanotube of the present example.

### Example 3

0.05 g of carbon nanotubes is added to 20 ml of deionized water (DI water) to provide a first solution (S1). Then, SnCl₂.6H₂O is added to the first solution and stirred at room temperature (S2). The stirred first solution is dried, the residues (in a form of powder) are collected and are processed by heat-treatment at 500° C. for 1 hour (S3). After heat treatment, residues are dispersed in ethylene glycol (reducing agent) to provide a second solution (S4). Herein, the SnCl₂.6H₂O used at step (S2) acts as the catalyst precursor of the present example.

Then, the second solution is heated to a temperature of 170° C. and H₂PtCl₆.6H₂O (a platinum precursor) is added thereto, the pH value of the solution is then adjusted to about 8 with potassium hydroxide (S5). Finally, the solution is stirred for about 20 minutes to dry and consequently the achieved powder is the hybrid catalyst with a structure of Pt/tin oxide/carbon-nanotube of the present example.

### Example 4

0.05 g of carbon nanotubes is added to 50 ml of anhydrous ethanol to provide a first solution (S1). Then, zinc acetate (Zn(O₂CCH₃)₂) is added to the first solution and stirred at room temperature (S2). The stirred first solution is dried, the residues (in a form of powder) are collected and are processed by heat-treatment at 700° C. for 1 hour (S3). After heat treatment, residues are dispersed in ethylene glycol (a reducing agent) to provide a second solution (S4). Herein, the Zn(O₂CCH₃)₂ used at step (S2) acts as the catalyst precursor of the present example.

Then, the second solution is heated to a temperature of 170° C. and H₂PtCl₆.6H₂O (a platinum precursor) is added thereto, the pH value of the solution is then adjusted to about 8 with potassium hydroxide (S5). Finally, the solution is stirred for about 20 minutes to dry and the achieved powder is thus the hybrid catalyst with a structure of Pt/zinc oxide/carbon-nanotube of the present example.

### Example 5

Except that the heat-treatment of step (S3) is omitted, the same method as described in the example 1 is used here to fabricate the Pt/cerium oxide/carbon-nanotube of the present example.

### Example 6

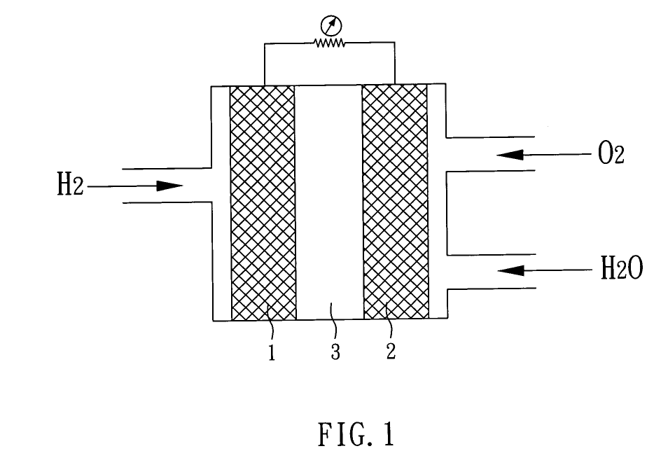

The objective of the present example is to provide a fuel cell. Referring to FIG. 1, a fuel cell of the present example is shown, which comprises an anode 1, a cathode 2, and an electrolyte membrane 3 disposed between the anode and the cathode. The anode 1 comprises a hybrid catalyst (not shown) that may be one selected from Pt/cerium oxide/carbon-nanotube, Pt/titanium oxide/carbon-nanotube, Pt/tin oxide/carbon-nanotube, and Pt/zinc oxide/carbon-nanotube, and the hybrid catalyst used herein is Pt/cerium oxide/carbon-nanotube provided from the example 1.

### Testing Example 1

### X-Ray Diffraction Analysis

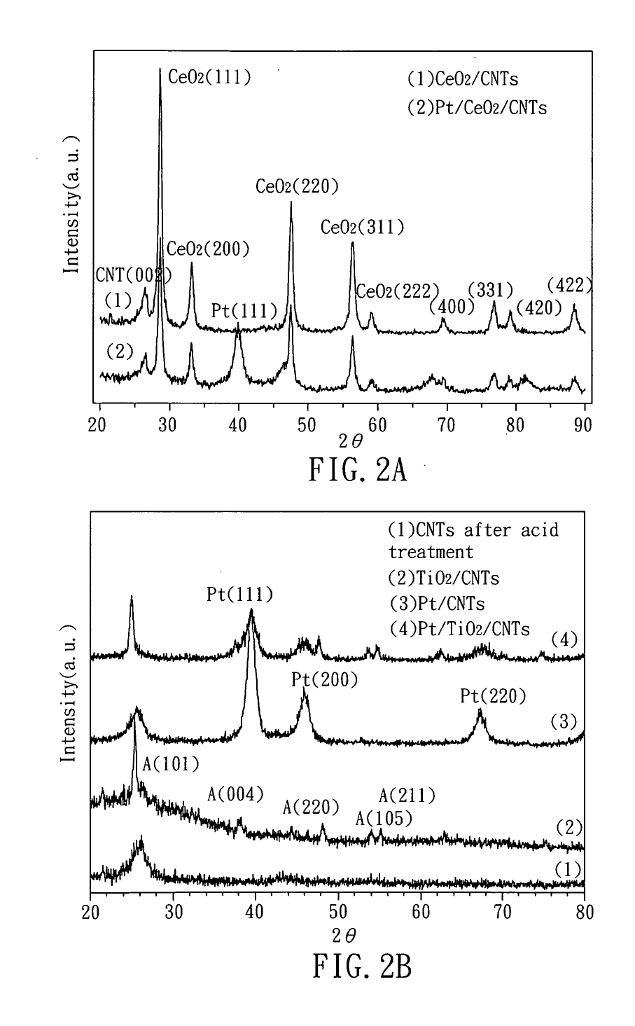

The hybrid catalysts provided from the example 1 and 2 are processed by X-ray diffraction analysis and the results are shown as FIGS. 2A and 2B.

Referring to FIG. 2A, it can be seen that the resulted peaks show an excellent crystalline characteristic of the hybrid catalyst with the structure of Pt/cerium oxide/carbon-nanotube of the example 1 (curve (2)). Also, the crystalline characteristic of the hybrid catalyst having the structure of Pt/titanium oxide/carbon-nanotube of the example 2 are observed from the X-ray diffraction analysis results of FIG. 2B (curve (4)), which means some of the atoms in the hybrid catalyst are orderly aligned.

### Testing Example 2

### Cyclic Voltammetry Experiment

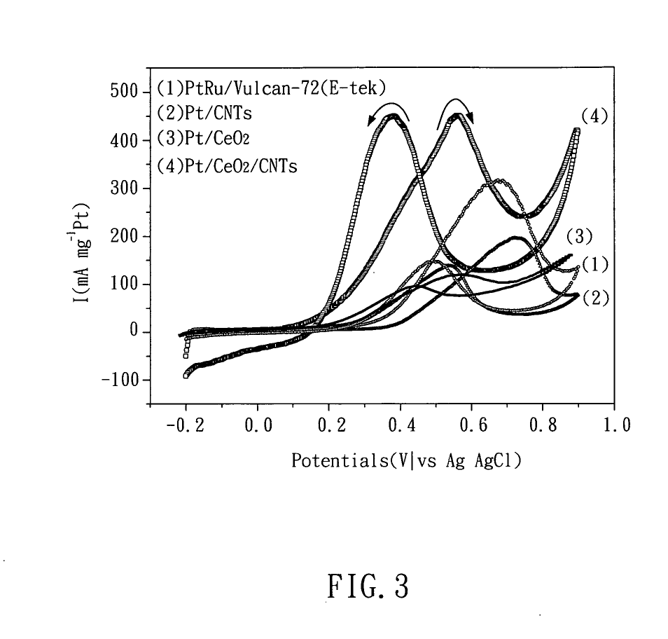

The hybrid catalyst with the structure of Pt/cerium oxide/carbon-nanotube of the example 1, carbon-nanotubes coated with Pt (Pt/CNTs), Pt/CeO₂ particles, and commercially obtained PtRu/Vulcan-72(E-tek) catalyst are taken for cyclic voltammetry test, and the results are represented as curves (1)-(4) respectively as shown in FIG. 3.

Referring to FIG. 3, it can be seen that the cyclic voltammetry testing result of the hybrid catalyst with the structure of Pt/cerium oxide/carbon-nanotube of the example 1 shows an excellent cyclic voltammetry characteristic (the curve (4)), in which a sufficient electric current is obtained even with a lower electric potential (voltage). In contrast, the cyclic voltammetry testing results of the PtRu/Vulcan-72(E-tek) catalyst, Pt/CNTs, and Pt/CeO₂ particles (curves (1), (2), (3) respectively) show a lower electric current even when a higher electric potential (voltage) is applied.

Therefore, it is apparent that the hybrid catalyst with the structure of Pt/cerium oxide/carbon-nanotube of the present invention has a better electro-chemical characteristic than the other catalysts.

### Testing Example 3

### Catalytic Activity Test—CO Oxidation Conversion Efficiency

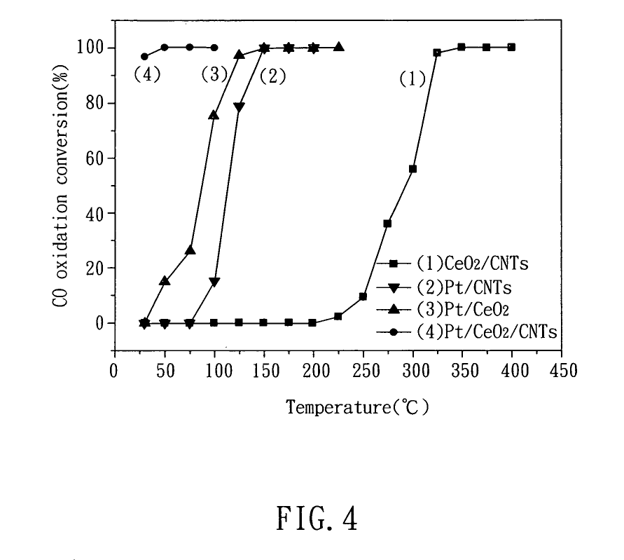

The hybrid catalyst with the structure of Pt/cerium oxide/carbon-nanotube of the example 1, carbon-nanotubes coated with Pt (Pt/CNT), Pt/CeO₂ particles, and commercially obtained PtRu/Vulcan-72(E-tek) catalyst are taken for CO oxidation conversion efficiency test, and the results are represented as curves (1)-(4) respectively as shown in FIG. 4.

Referring to the curve (4) of FIG. 4, it can be seen that an excellent CO oxidation conversion efficiency of the hybrid catalyst with the structure of Pt/cerium oxide/carbon-nanotube of the example 1 is obtained (about 100%) even though the temperature is low. Besides, 90% or more of the CO oxidation conversion efficiency is performed while no heat is applied at the beginning of the CO oxidation conversion test. Therefore, it is obvious that the hybrid catalyst with the structure of Pt/cerium oxide/carbon-nanotube of the present invention is useful for detoxifying the CO poisoning. Moreover, the catalytic activity of the hybrid catalyst of the present invention cannot be influenced by the CO concentration, which means a high catalytic activity is performed even when the CO content is high in the surrounded environment.

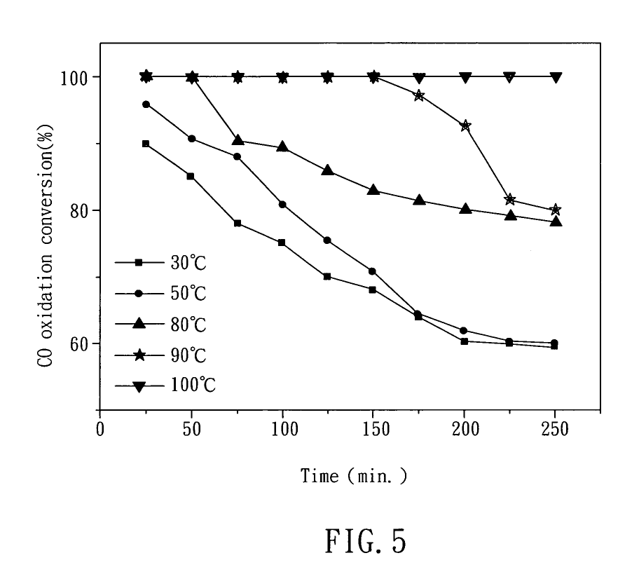

Another catalytic activity testing applies different temperatures to the hybrid catalyst with the structure of Pt/cerium oxide/carbon-nanotube of the present invention to test the CO oxidation conversion efficiency, and the results are shown in FIG. 5. Referring to FIG. 5, 60% or more of the CO oxidation conversion efficiency is performed even when the hybrid catalyst is working through about 250 minutes while no heat is applied (the curve marked with 30° C.). When the hybrid catalyst of the present invention is heated to 100° C. (the curve marked with 100° C.), about 100% of the CO oxidation conversion efficiency can be maintained through a long period of time such as 250 minutes or longer. Therefore, it is obvious that either at a lower or a higher temperature, the hybrid catalyst with the structure of Pt/cerium oxide/carbon-nanotube of the present invention can perform excellent CO oxidation conversion efficiency that cannot be achieved with the conventional catalysts.

The hybrid catalyst with the structure of Pt/cerium oxide/carbon-nanotube of the present invention utilizes a metal compound having oxygen, such as cerium oxide, to act as the oxygen donor for converting the carbon mono-oxide attached at the surface of the platinum into carbon dioxide, and thus enables the regeneration of the activity of the platinum and elongates the life time of the platinum.

Catalysts such as Pt/CNTs, Pt/CeO₂, and CeO₂/CNTs as represented with curves (2), (3), and (1) respectively in FIG. 4 cannot execute about 100% of CO oxidation conversion efficiency even if the temperature reaches 100° C. For example, the catalyst of Pt/CeO₂ should be heated to 320° C. or over thus the CO oxidation conversion efficiency can be largely increased (curve (1)), whereas almost only 0% of CO oxidation conversion efficiency is performed when the temperature is under 200° C.

Therefore, the hybrid catalyst with the structure of Pt/oxygen donor/carbon-nanotube of the present invention has an excellent CO oxidation conversion efficiency (about 100%) even though the environmental temperature is low, for example, about 100° C. At least 90% of the CO oxidation conversion efficiency of the hybrid catalyst of the present invention is still kept at a room temperature, which cannot be realized by the conventional catalyst.

As mentioned above, it is known that the hybrid catalyst with the structure of Pt/oxygen donor/carbon-nanotube of the present invention has an excellent electro-chemical characteristic from the testing result of the cyclic voltammetry experiment. Also, from the testing results of CO oxidation conversion efficiency test, it can be seen that about 100% of CO oxidation conversion efficiency can be reached without very high heating temperature. Therefore, the hybrid catalyst with the structure of Pt/oxygen donor/carbon-nanotube of the present invention is effective in detoxifying the CO poisoning.

The hybrid catalyst with the structure of Pt/oxygen donor/carbon-nanotube of the present invention utilizes a metal compound having oxygen, such as cerium oxide, to act as the oxygen donor for converting the carbon mono-oxide attached at the surface of the platinum into carbon dioxide, and thus enables the regeneration of the activity of the platinum and elongates the life time of the catalyst. The costs involved are low since the material of the oxygen donor used in the present example such as cerium oxide, titanium oxide, tin oxide, or zinc oxide is inexpensive compared with the ruthenium metal used in those prior arts. Therefore, the hybrid catalyst of the present invention is undoubtedly a novel hybrid catalyst having excellent electro-chemical performance and high industrial application potential.

Although the present invention has been explained in relation to its preferred embodiment, it is to be understood that many other possible modifications and variations can be made without departing from the scope of the invention as hereinafter claimed.

What is claimed is:

1. A hybrid catalyst, comprising:
a carbon-nanotube;
an oxygen donor formed on the surface of the carbon-nanotube, wherein the oxygen donor is a metal compound containing at least one oxygen atom, the metal of the metal compound is selected from a group consisting of: cerium, titanium, tin, zinc, and the mixture thereof; and
platinum formed on the surface of the oxygen donor.

2. The hybrid catalyst as claimed in claim 1, wherein the oxygen donor is selected from the group consisting of: cerium oxide, titanium oxide, tin oxide, zinc oxide, and the mixture thereof.

3. The hybrid catalyst as claimed in claim 2, wherein the oxygen donor is cerium oxide.

4. The hybrid catalyst as claimed in claim 2, wherein the oxygen donor is titanium oxide.

5. The hybrid catalyst as claimed in claim 1, wherein the hybrid catalyst is used in an anode of a fuel cell.

6. A method of fabricating a hybrid catalyst, comprising:
(S1) adding carbon nanotubes to a first solvent;
(S2) adding a catalyst precursor into the first solvent with carbon nanotubes to form a first solution mixture, wherein the catalyst precursor is selected from the group consisted of: cerium compound, titanium compound, tin compound, zinc compound, and the mixture thereof;
(S3) drying the first solution mixture of step (S2) to form a dried residue;
(S4) dispersing the dried residue in a second solvent;
(S5) adding a platinum precursor to the second solvent to form a second solution mixture; and
(S6) drying the second solution mixture to achieve the hybrid catalyst having a structure of Pt/oxygen donor/carbon-nanotube.

7. The method of fabricating a hybrid catalyst as claimed in claim 6, wherein the first solvent in the step (S1) is selected from the group consisting of: alcohols, acids, ketones, and the mixture thereof.

8. The method of fabricating a hybrid catalyst as claimed in claim 7, wherein the first solvent is IPA (isopropyl alcohol), ethanol, propanol, cittric acid, polyethylene glycol, stearic acid, or an alcohol having eight or more carbon atoms.

9. The method of fabricating a hybrid catalyst as claimed in claim 6, wherein the second solvent in the step (S4) is selected from the group consisting of an alcohol, water, and the mixture thereof.

10. The method of fabricating a hybrid catalyst as claimed in claim 6, further comprising a step (S31) after the step (S3), wherein the step (S31) is: performing heat-treatment to the dried residue.

11. The method of fabricating a hybrid catalyst as claimed in claim 10, wherein the temperature of the heat-treatment of the step (S31) is 300° C. or above.

12. The method of fabricating a hybrid catalyst as claimed in claim 6, wherein the catalyst precursor in the step (S2) is a metal salt.

13. The method of fabricating a hybrid catalyst as claimed in claim 6, wherein the catalyst precursor in the step (S2) is a metal alkoxide.

14. The method of fabricating a hybrid catalyst as claimed in claim 6, further comprising a step (S41) after the step (S4), wherein the step (S41) is: heating the second solvent with the added residue.

15. The method of fabricating a hybrid catalyst as claimed in claim 14, wherein the heating temperature of the step (S41) is 150 to 200° C.

16. The method of fabricating a hybrid catalyst as claimed in claim 6, further comprising a step (S51) after the step (S5), wherein the step (S51) is: adjusting the pH value of the second solution mixture to 7˜9.

17. A fuel cell, comprising:
an anode having a hybrid catalyst;
a cathode; and
an electrolyte membrane disposed between the anode and the cathode;
wherein the hybrid catalyst comprises a carbon-nanotube; an oxygen donor; and platinum, wherein the oxygen donor is formed on the surface of the carbon-nanotube, the oxygen donor is a metal compound containing at least one oxygen atom, the metal of the metal compound is selected from a group consisting of: cerium, titanium, tin, zinc, and the mixture thereof, and the platinum formed on the surface of the oxygen donor.

18. The fuel cell as claimed in claim 17, wherein the oxygen donor is selected from the group consisting of: cerium oxide, titanium oxide, tin oxide, zinc oxide, and the mixture thereof.

19. The fuel cell as claimed in claim 18, wherein the oxygen donor is cerium oxide or titanium oxide.
